(19) United States
(12) Patent Application Publication
(10) Pub. No.: US 2013/0269359 A1
(43) Pub. Date: Oct. 17, 2013

(54) COMBUSTOR FLOW SLEEVE WITH SUPPLEMENTAL AIR SUPPLY

(71) Applicant: Michael John HUGHES, Greer, SC (US)

(72) Inventor: Michael John HUGHES, Greer, SC (US)

(73) Assignee: GENERAL ELECTRIC COMPANY, Schenectady, NY (US)

(21) Appl. No.: 13/447,542

(22) Filed: Apr. 16, 2012

(51) Int. Cl. F02C 3/14; F23R 3/28; F23R 3/16

(52) U.S. Cl. 60/772; 60/740; 60/39.37

(57) ABSTRACT

A gas turbine combustor includes a combustor liner enclosing a combustion chamber; at least one fuel nozzle arranged to provide fuel to the combustion chamber; a flow sleeve surrounding the combustor liner forming a passage radially between the combustor liner and the flow sleeve for supplying air to the combustion chamber, the flow sleeve configured to permit air to flow substantially axially into the passage via a substantially annular flow sleeve inlet. A downstream end of the flow sleeve is formed to include an annular manifold provided with plural outlets about a circumference of the downstream end of the flow sleeve and adapted to supply supplemental air from an external variable air source substantially radially into the passage to thereby maintain axial air flow boundary layer attachment at the flow sleeve inlet.

### BACKGROUND OF THE INVENTION

This invention relates generally to gas turbine engines and more particularly, to gas turbine combustor assemblies.

At least some known gas turbine engines use cooling air to cool a combustion assembly within the engine. Moreover, oftentimes the cooling air is supplied from a compressor coupled in flow communication with the combustion assembly. For example, in at least some known gas turbine engines, the cooling air is discharged from the compressor into a plenum extending at least partially around a transition piece of the combustor assembly. A first portion of the cooling air entering the plenum is supplied to an impingement sleeve surrounding the transition piece prior to entering a cooling channel radially between the impingement sleeve and the transition piece. Cooling air entering the cooling channel is discharged into a second, aligned cooling channel radially between a combustor liner and a flow sleeve. The remaining cooling air entering the plenum is channeled through inlets formed within the flow sleeve and also discharged into the second cooling channel.

In combustion systems for industrial-turbines generally as described above, multiple independent combustor cans are equally spaced around the centerline of the machine. These are referred to “can-annular” systems. There are many benefits to these types of systems, but one of the drawbacks is that each combustion can will experience a different amount of inlet airflow due to factors such as part tolerances, obstructions in the inlet, non-integral stage-one nozzle counts downstream of the combustors, etc. Also, the amount of fuel entering each combustor can will be slightly different due to variation in fuel nozzle effective areas, obstacles in piping and manifolds, etc. As a result, each can will have a different fuel/air ratio, which can drive variations in performance of each can. In most cases, it is desirable to have all of the cans perform as close to the design point as possible.

As mentioned above, most combustion systems use a reverse-flow cooling arrangement meaning that the air that will eventually be used for combustion is first used for cooling. Impingement jets, turbulators and other types of structures are used to augment heat transfer at the expense of pressure drop. In a good combustion system design, most of the pressure drop is directly used for cooling, and very little is due to flow separations and other sources of pressure loss that do not influence cooling.

In state-of-the-art air cooled combustion systems, an axial-injection-type flow sleeve surrounds each combustor liner and air that is not used to cool the transition piece (for example, by impingement cooling) is injected along the centerline of the combustor so as not to waste any of the potential energy used to force the air inside the liner/flow sleeve annulus as occurs with radial-injection flow sleeves.

The air is intended to enter the annulus between the flow sleeve and the combustor liner cleanly; however, it has been found that flow separation occurs at the inlet, along the inside surface of the flow sleeve, causing increased pressure loss. One solution to this problem utilizes surface contouring on the inside surface of the flow sleeve which allows the flow to stay attached and then diffuse over some length within the annulus.

While this solution is satisfactory in some respects, it has been determined that it would be desirable to control the flow of air at the entry to the annulus between the combustor liner and flow sleeve so as to modify flow behavior at the inlet anywhere between fully-separated and fully-attached conditions.

### BRIEF SUMMARY OF THE INVENTION

In accordance with an exemplary but nonlimiting embodiment, the invention provides a gas turbine combustor comprising a combustor liner enclosing a combustion chamber; at least one fuel nozzle arranged to provide fuel to the combustion chamber; a flow sleeve surrounding the combustor liner forming a passage radially between the combustor liner and the flow sleeve for supplying air to the combustion chamber, the flow sleeve configured to permit air to flow substantially axially into the passage via a substantially annular flow sleeve inlet; a downstream end of the flow sleeve formed to include an annular manifold provided with plural outlets about a circumference of the downstream end of the flow sleeve and adapted to supply supplemental air from an external variable air source substantially radially into the passage to thereby maintain axial air flow boundary layer attachment at the flow sleeve inlet.

In another aspect, the invention provides a can-annular combustor arrangement for a gas turbine comprising plural combustors arranged in an annular array about a turbine rotor, the plural combustors adapted to supply combustion gases to a first stage of the gas turbine; each combustor comprising a combustor liner enclosing a combustion chamber, at least one fuel nozzle arranged to provide fuel to the combustion chamber, a flow sleeve surrounding the combustor liner forming a passage radially between the combustor liner and the flow sleeve for supplying air to the combustion chamber; wherein a downstream end of the flow sleeve is formed to include an annular manifold provided with plural outlets about a circumference of the downstream end of the flow sleeve and adapted to supply supplemental air from an external variable air source to the passage.

In still another aspect, the invention provides a method of controlling flow of air to any one or all of a plurality of combustors in a can-annular array of combustors about a gas turbine rotor, where each combustor includes a liner enclosing a combustion chamber and supports at least one nozzle for supplying fuel to the combustion chamber; and a flow sleeve surrounding the combustor liner, with an annular passage extending between the liner and the flow sleeve for supplying compressor discharge air to the combustion chamber via an axially-oriented inlet at the downstream end of the flow sleeve, the method comprising supplying supplemental air under pressure selectively to the annular passage of each of the plurality of combustors; and modulating flow of the supplemental air to control a fuel/air ratio for any one or all of the plurality of combustors.

The invention will now be described in detail in connection with the drawings identified below.

### BRIEF DESCRIPTION OF THE DRAWINGS

FIG. 1 is a schematic cross-sectional illustration of an exemplary gas turbine engine.

FIG. 2 is an enlarged cross-sectional illustration of a portion of an exemplary combustor assembly that may be used with the gas turbine engine shown in FIG. 1;

FIG. 3 is an enlarged partial cross section illustrating a known combustor flow sleeve inlet configuration showing an idealized flow pattern for air flowing axially into an annulus between the flow sleeve and combustor liner;

FIG. 4 is a view similar to FIG. 3 but showing an actual flow pattern for the air entering the annulus;

FIG. 5 is a partial cross section of a combustor flow sleeve in accordance with an exemplary but nonlimiting embodiment of the invention supplying supplemental air to the annulus and its effect on the air flowing axially into the annulus;

FIG. 6 is a view similar to FIG. 5 but showing the flow pattern when the supplemental air supply system is in the “off” position; and

FIG. 7 is a schematic diagram illustrating a supplemental air supply system for a can-annular array of combustors in accordance with an exemplary but nonlimiting embodiment of the invention.

### DETAILED DESCRIPTION OF THE INVENTION

At the outset, it is noted that, as used herein, “upstream” refers to a forward end of a gas turbine engine or other component in the combination gas flow path, and “downstream” refers to an aft end of a gas turbine engine or other component in the combustion gas flow path.

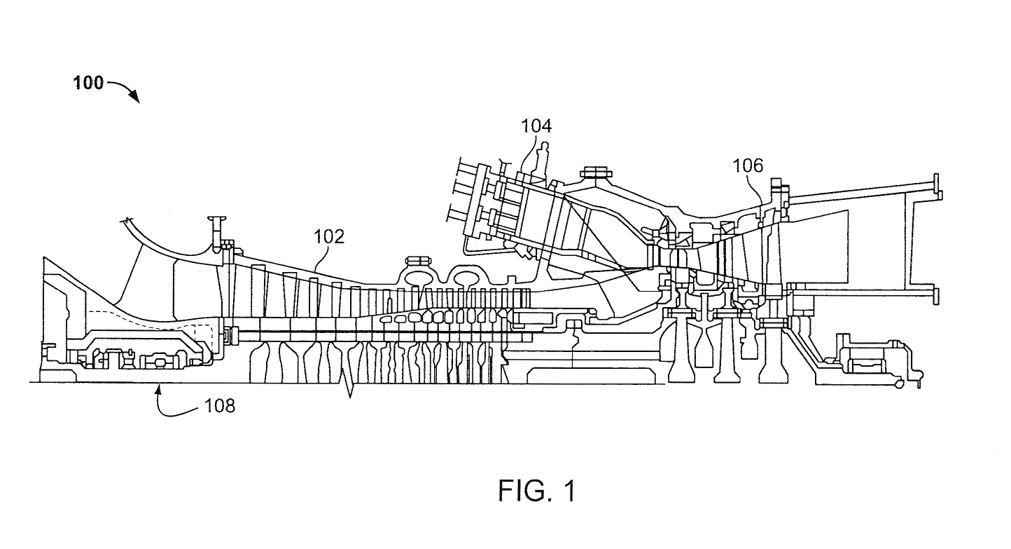

FIG. 1 is a schematic cross-sectional illustration of an exemplary gas turbine engine 100. Engine 100 includes a compressor assembly 102, a combustor assembly 104, a turbine assembly 106 and a common compressor/turbine rotor shaft 108. It should be noted that engine 100 is exemplary only, and that the present invention may instead be implemented within any gas turbine engine that functions generally as described herein.

In operation, air flows through compressor assembly 102 and compressed air is discharged to combustor assembly 104. Combustor assembly 104 injects fuel, for example, natural gas and/or fuel oil, into the air flow; ignites the fuel-air mixture to expand the fuel-air mixture through combustion; and generates a high temperature combustion gas stream. Combustor assembly 104 is in flow communication with the compressor assembly 102 and the turbine assembly 106, and discharges the high temperature expanded gas stream into turbine assembly 106. The high temperature expanded gas stream imparts rotational energy to turbine assembly 106 and because turbine assembly 106 is rotatably coupled to rotor 108, rotor 108 subsequently provides rotational power to compressor assembly 102.

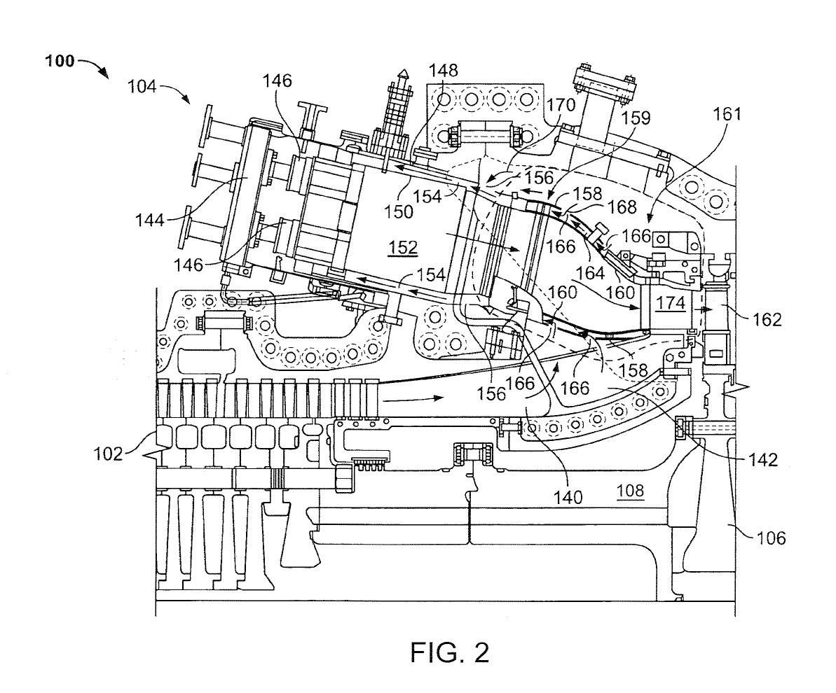

FIG. 2 is an enlarged cross-sectional illustration of a portion of the compressor assembly 102 and the combustor assembly 104. Compressor assembly 102 includes a diffuser 140 and a discharge plenum 142, that are coupled to each other in flow communication to facilitate channeling air downstream to the combustor assembly 104.

In the exemplary embodiment, combustor assembly 104 includes a substantially circular endcover or cover plate 144 that at least partially supports a plurality of fuel nozzles 146. The cover plate 144 is coupled to a substantially cylindrical combustor flow sleeve 148 with retention hardware (not shown). A substantially cylindrical combustor liner 150 is positioned within the flow sleeve 148 and is supported via the flow sleeve. A substantially cylindrical combustor chamber 152 is defined by liner 150. More specifically, liner 150 is spaced radially inward from flow sleeve 148 such that an annular combustion liner cooling passage or annulus 154 is defined between combustor flow sleeve 148 and combustor liner 150. Flow sleeve 148 includes a plurality of inlets 156 which provide an axially-oriented flow path into the cooling passage or annulus 154.

In some turbine configurations, an impingement sleeve 158 is coupled to the combustor flow sleeve 148 at an upstream end 159 of the impingement sleeve 158, and substantially surrounds a transition piece or duct 160 that channels the combustion gases generated in chamber 152 to the turbine, represented by the turbine nozzle 174. A transition piece cooling passage or annulus 164 is thus defined between the impingement sleeve 158 and the transition piece 160. A plurality of openings 166 defined within impingement sleeve 158 enable a portion of air flow from compressor discharge plenum 142 to be directed radially into transition piece cooling passage or annulus 164 where it flows along and through the annulus 164 and continues into the passage or annulus 154.

In operation, compressor assembly 102 is driven by turbine assembly 106 via shaft 108 (shown in FIG. 1). As compressor assembly 102 rotates, it compresses air and discharges compressed air into the diffuser 140 as indicated in FIG. 2 by a plurality of flow arrows. In the exemplary embodiment, the majority of air discharged from compressor assembly 102 is channeled through compressor discharge plenum 142 towards combustor assembly 104, and a smaller portion of air discharged from compressor assembly 102 is channeled downstream for use in cooling components of the engine 100. More specifically, a first flow leg 168 of the pressurized compressed air within plenum 142 is channeled into transition piece cooling passage or annulus 164 via radially-oriented impingement sleeve openings 166. The air is then channeled upstream within transition piece cooling passage or annulus 164 and discharged into combustion liner cooling passage or annulus 154. In addition, a second flow leg 170 of the pressurized compressed air within plenum 142 is channeled around impingement sleeve 158 and injected substantially axially into combustion liner cooling passage 154 via inlets 156. Air entering inlets 156 and air from transition piece cooling passage 164 is then mixed within passage 154 and is then discharged from passage 154 into fuel nozzles 146 wherein it is mixed with fuel and ignited within combustion chamber 152. For turbine models or configurations that do not employ an impingement sleeve about the transition piece, the compressor discharge air flows axially into the annulus 154 between the flow sleeve 148 and the combustor liner 150 via inlets 156. It will be appreciated that the invention described herein is applicable to both arrangements.

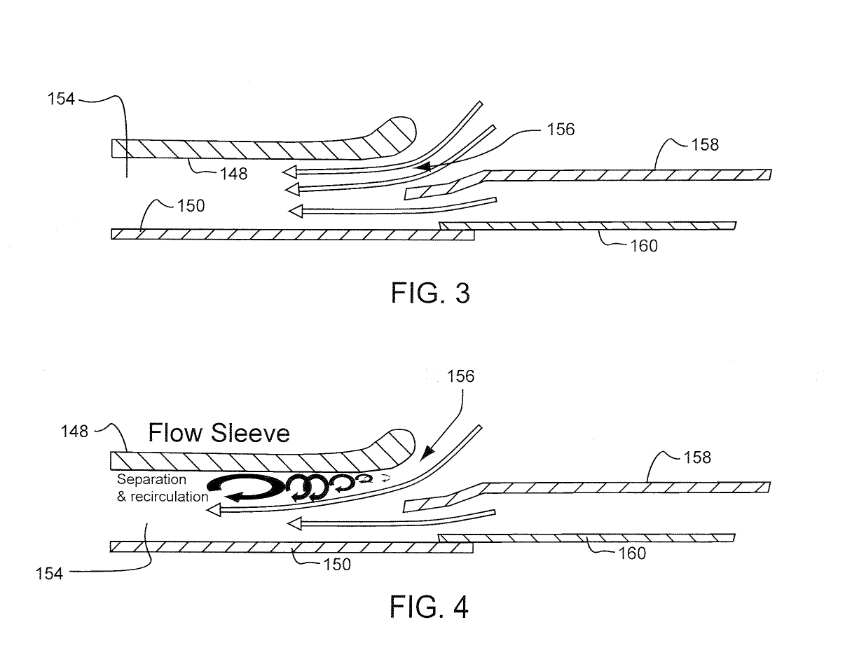

FIG. 3 is an enlarged detail showing the introduction of compressor discharge cooling air into the liner cooling passage or annulus 154 via the circumferential opening or inlet 156 (opening 156 may be sectioned by struts (not shown) that support the aft end of the flow sleeve 148). The air flow streams are shown in an “idealized” pattern, where the boundary flow remains attached to the inside surface of the flow sleeve 148.

FIG. 4 illustrates actual air flow introduced through the inlets 156 where separation and recirculation of the air (i.e., turbulence) along the inside surface of the flow sleeve 148 causes an undesirable increase in pressure drop.

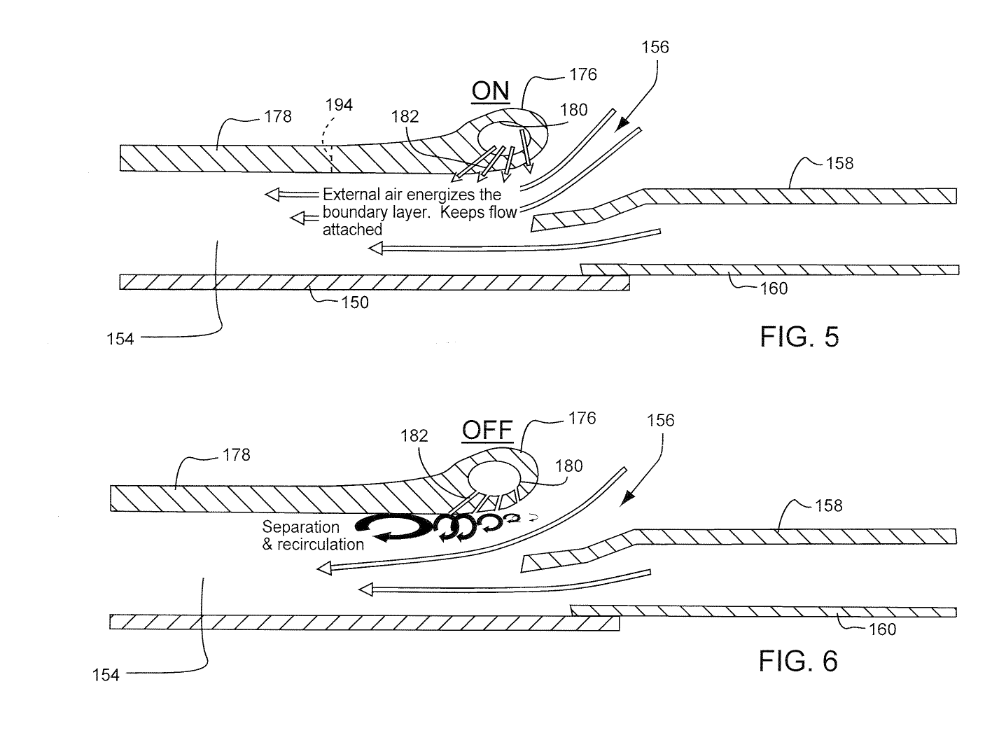

FIG. 5 illustrates an exemplary but nonlimiting embodiment of this invention. The enlarged aft end 176 of the flow sleeve 178 has been reconfigured to incorporate an annular manifold 180 that distributes additional or supplemental air under pressure into the annular passage 154 at the inlet 156. Air distribution holes 182 are located about the periphery of the flow sleeve aft end 176, in communication with the manifold 180, and preferably angled variably to introduce the air generally radially but with a flow component in the direction of flow of the cooling air in passage 154. By supplying additional air under higher pressure than the cooling air flowing axially through the passage 154 in this manner, the separation and recirculation shown in FIG. 4 is substantially eliminated.

The supplemental air flow fed through the manifold 180 and blown into the annulus 154 can be adjusted from “full-on” to “full-off” positions and anywhere in between, as will be described in greater detail below. FIG. 6 shows the flow in the full-off condition, such that the flow separation and recirculation reoccurs, similar to the flow pattern illustrated in FIG. 4.

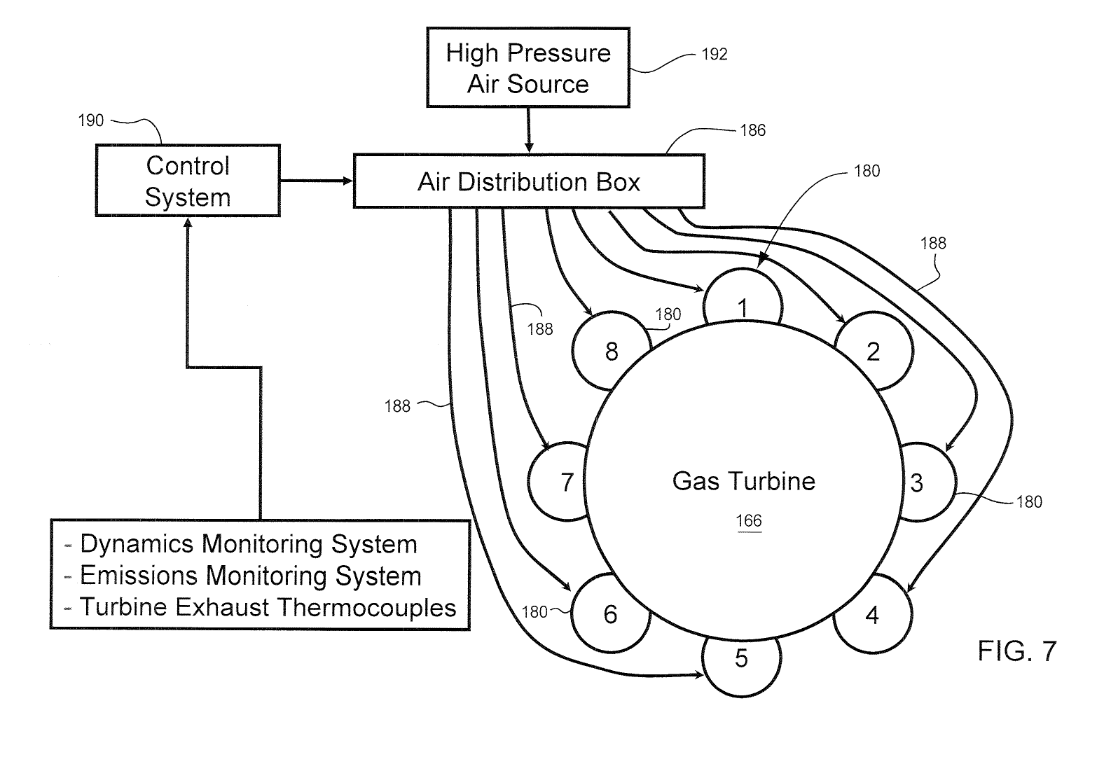

Referring now to FIG. 7, an exemplary air distribution system is illustrated for supplying supplemental air to the liner aft manifolds 180 of each of eight (8) combustors (numbered 1-8) in a can-annular array of combustors about a turbine 184. Thus, in an exemplary eight-combustor arrangement, an air distribution box 186 can selectively supply supplemental air via individual conduits 188 to any or all of the manifolds 180. It will be appreciated that the invention also contemplates employing multiple conduits to supply air to a single manifold 180, thus permitting air to be selectively routed to specific locations within a single combustor. The air distribution box, in turn, is controlled by a control system 190 which also receives input from certain subsystems of the gas turbine 184, for example, a dynamics monitoring system, emissions monitoring system, turbine exhaust temperature monitoring system and/or the turbine main controller.

Air may be supplied to the air distribution box 186 from a high pressure, external source 192.

This arrangement permits independent and selective control of the additional or supplemental air supplied to the manifolds 164 of the respective combustors 1-8 in order to optimize the performance of each.

In other words, this so-called “boundary layer blowing” is used to control the aerodynamic performance of the inlet to the combustor liner/flow sleeve passage 154 of each combustor by modulating the amount of supplemental air introduced via the manifolds 180 and air distribution holes 182, and thus not only modulating the pressure loss at each combustor, but also permitting adjustments to the fuel/air ratio in each combustor.

With respect to the manifolds 180, they may be cast in place integrally with the flow sleeve 178, or formed as split flow sleeve ends welded in place (as indicated by the weld line 194 shown in phantom in FIG. 5). The distribution holes 182 may be uniformly distributed about the flow sleeve periphery, or they may be arranged in discrete groups located symmetrically about the periphery, or at locations dictated by the arrangement of fuel nozzles within the combustor. The air supplied to the discrete groups of outlet holes 182 could also be individually controlled within a single combustor by subdividing the manifold into discrete segments.

The supplemental air introduced via the outlet holes 182 could also be taken from a substantially constant volume of air within the manifold 180 by means of piezoelectric devices that can be switched to “pump” air into the stream or passage 154 and then switched to “pull” air back into the manifold.

It can thus be appreciated that the invention as described may be altered in any of several ways to control air flow at the inlets 156 to the passage 154 and thus selectively control combustor performance and emissions for each of the several combustors in a can-annular array.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gas turbine combustor comprising:
a combustor liner enclosing a combustion chamber;
at least one fuel nozzle arranged to provide fuel to the combustion chamber; a flow sleeve surrounding the combustor liner forming a passage radially between the combustor liner and the flow sleeve for supplying air to the combustion chamber, said flow sleeve configured to permit air to flow substantially axially into said passage via a substantially annular flow sleeve inlet; a downstream end of said flow sleeve formed to include an annular manifold provided with plural outlets about a circumference of said downstream end of said flow sleeve and adapted to supply supplemental air from an external variable air source substantially radially into said passage to thereby maintain axial air flow boundary layer attachment at said flow sleeve inlet.

2. The gas turbine combustor of claim 1 wherein said manifold is formed integrally with said downstream end of said flow sleeve.

3. The gas turbine combustor of claim 1 wherein at least some of said plural outlets are variably slanted in a direction of flow within the passage.

4. The gas turbine combustor of claim 1 wherein said downstream end of said flow sleeve includes a discrete, enlarged portion to accommodate said manifold, joined to said flow sleeve.

5. The gas turbine combustor of claim 1 wherein said variable air source comprises a high pressure source connected to an air distribution box.

6. The gas turbine combustor of claim 5 wherein said air distribution box is controlled by a controller with inputs from one or more of a dynamics monitoring system, an emissions monitoring system, a turbine exhaust temperature monitoring system and a turbine main controller.

7. A can-annular combustor arrangement for a gas turbine comprising:
plural combustors arranged in an annular array about a turbine rotor, said plural combustors adapted to supply combustion gases to a first stage of the gas turbine; each combustor comprising a combustor liner enclosing a combustion chamber, at least one fuel nozzle arranged to provide fuel to the combustion chamber, a flow sleeve surrounding the combustor liner forming a passage radially between the combustor liner and the flow sleeve for supplying air to the combustion chamber; wherein a downstream end of said flow sleeve is formed to include an annular manifold provided with plural outlets about a circumference of said downstream end of said flow sleeve and adapted to supply supplemental air from an external variable air source to said passage.

8. The can-annular combustor arrangement of claim 7 wherein said manifold is formed integrally with said downstream end of said flow sleeve.

9. The can-annular combustor of claim 7 wherein at least some of said plural outlets are variably slanted in a direction of flow within the passage.

10. The can-annular combustor of claim 7 wherein said downstream end of said flow sleeve includes a discrete, enlarged portion to accommodate said manifold, joined to said flow sleeve.

11. The can-annular combustor arrangement of claim 7 wherein each manifold is connected to an air distribution box supplied with air from a high pressure source.

12. The can-annular combustor arrangement of claim 11 wherein said air distribution box is connected to a control system that is programmed to separately control an amount of air blown into the respective passage of each combustor.

13. The can-annular combustor arrangement of claim 12 wherein said control system receives inputs from one or more of a dynamics monitoring system, an emissions monitoring system, a turbine exhaust temperature monitoring system and a turbine main controller.

14. A method of controlling flow of air to any one or all of a plurality of combustors in a can-annular array of combustors about a gas turbine rotor, where each combustor includes a liner enclosing a combustion chamber and supports at least one nozzle for supplying fuel to the combustion chamber; and a flow sleeve surrounding the combustor liner, with an annular passage extending between the liner and the flow sleeve for supplying compressor discharge air to the combustion chamber via an axially-oriented inlet at the downstream end of the flow sleeve, the method comprising:
(a) supplying supplemental air under pressure selectively to said annular passage of each of said plurality of combustors; and
(b) modulating flow of the supplemental air to control a fuel/air ratio for any one or all of said plurality of combustors.

15. The method of claim 14 including selectively supplying the supplemental air from a common air distribution box to each of said plurality of combustors.

16. The method of claim 15 wherein said air distribution box is controlled by a controller receiving inputs from one or more of a dynamics monitoring system, an emissions monitoring system, a turbine exhaust temperature monitoring system and a turbine main controller.

17. The method of claim 14 including, in step (a), supplying the supplemental air via multiple outlets in an aft end of the flow sleeve.

18. The method of claim 17 including angling at least some of the multiple outlets variably in a direction of flow within the passage.

19. The method of claim 17 including providing an annular manifold within said aft end of said flow sleeve, said multiple outlets in communication with said manifold.

20. The method of claim 14 wherein, in step (b), the supplemental air flow is modulated anywhere between full-off and full-on positions.
